(19) United States
(12) Patent Application Publication
(10) Pub. No.: US 2025/0054092 A1
(43) Pub. Date: Feb. 13, 2025

(54) SYSTEMS AND METHODS FOR TISSUE IMAGING

(71) Applicant: SurgiVance, Inc., New York, NY (US)

(72) Inventor: Daniel Summer Gareau, New York, NY (US)

(21) Appl. No.: 18/931,807

(22) Filed: Oct. 30, 2024

Related U.S. Application Data
(63) Continuation-in-part of application No. 18/646,604, filed on Apr. 25, 2024.
(60) Provisional application No. 63/462,033, filed on Apr. 26, 2023.
(60) Provisional application No. 63/461,687, filed on Apr. 25, 2023.
(60) Provisional application No. 63/522,542, filed on Jun. 22, 2023.

(51) Int. Cl. G06T 1/00; G01N 1/28

(52) U.S. Cl. CPC G06T 1/0007; G01N 1/28; G06T 2207/30024

(57) ABSTRACT

In accordance with an aspect of the present disclosure, a tissue imaging system includes a cassette configured to retain a tissue for imaging. The cassette includes a first cassette portion and a second cassette portion. The first cassette portion includes a recess formed in a central portion thereof, a window formed within the recess, and a first connection mechanism affixed thereto. The second cassette portion includes a cavity configured to compress a tissue therein and a second connection mechanism affixed thereto. An imaging device is configured to image the tissue through the window. Aligning the first connection mechanism and the second connection mechanism causes the first cassette portion to couple to the second cassette portion, compressing the tissue into the cavity for imaging.

### CROSS REFERENCE TO RELATED APPLICATIONS

The present application is a continuation-in-part and claims the benefit of and priority to U.S. patent application Ser. No. 18/646,604, filed on Apr. 25, 2024, which in turn claims the benefit of and priority to U.S. Provisional Patent Application No. 63/462,033, filed on Apr. 26, 2023, U.S. Provisional Patent Application No. 63/461,687, filed on Apr. 25, 2023, and U.S. Provisional Patent Application No. 63/522,542, filed on Jun. 22, 2023, the entire contents of each of which are hereby incorporated by reference in their entirety.

### TECHNICAL FIELD

The present disclosure relates to systems and methods for tissue imaging, and, more specifically, to systems and methods for tissue imaging using a cassette.

### BACKGROUND

Confocal microscopy is an advanced optical imaging technique used to obtain high-resolution images of specimens. By offering superior optical sectioning capabilities compared to conventional wide-field microscopy, confocal microscopy allows a user to capture detailed three-dimensional views of structures with exceptional clarity and resolution. Current confocal microscopy cassettes, or imaging chambers, can present several challenges during the imaging process. Maintaining a stable environment (e.g., temperature, humidity, and/or gas concentration) can be challenging, especially for live imaging where cells are sensitive to environmental changes. Moreover, samples may not adhere well to the chamber surface or may deform under the conditions required for confocal imaging (e.g., immersion in a specific medium, temperature control). In addition, any scratches and/or impurities during assembly can introduce artifacts or reduce image clarity.

Accordingly, there is a continuing need for improved tissue imaging systems.

### SUMMARY

In accordance with an aspect of the present disclosure, a tissue imaging system includes a cassette configured to retain a tissue for imaging. The cassette includes a first cassette portion and a second cassette portion. The first cassette portion includes a recess formed in a central portion thereof, a window formed within the recess, and a first connection mechanism affixed thereto. The second cassette portion includes a cavity configured to compress a tissue therein and a second connection mechanism affixed thereto. An imaging device is configured to image the tissue through the window. Aligning the first connection mechanism and the second connection mechanism causes the first cassette portion to couple to the second cassette portion, compressing the tissue into the cavity for imaging.

In an aspect of the present disclosure, the imaging device may be a solid-state confocal microscope.

In another aspect of the present disclosure, the first connection mechanism and the second connection mechanism may each include a magnet.

In yet another aspect of the present disclosure, the cavity may be substantially the same size as the recess and cavity may be configured to receive recess therein when the first cassette portion and the second cassette portion are aligned.

In a further aspect of the present disclosure, a lower surface of the first cassette portion may be substantially flush with an upper surface of the second cassette portion when the first cassette portion and the second cassette portion are aligned.

In yet a further aspect of the present disclosure, the imaging device may include a temperature-controlled plate configured to maintain a temperature of the tissue in a range of approximately four to approximately six degrees Celsius.

In another aspect of the present disclosure, the tissue imaging system may include a fixation magnet affixed to the second cassette portion. The fixation magnet may be configured to magnetically couple the second cassette portion to the temperature-controlled plate.

In yet another aspect of the present disclosure, the recess may include a gel configured to adhere the tissue within the recess and maintain a position of the tissue therein. The gel may include agarose, formaldehyde, and/or dimethyl sulfoxide.

In a further aspect of the present disclosure, the tissue imaging system may include a calibration component affixed to the second cassette portion. The calibration component may be configured to evaluate a performance metric of the imaging device based on light reflected towards a reflection target on the window.

In yet a further aspect of the present disclosure, the calibration component may include a fluorescent film and/or fluorescent microspheres.

In accordance with an aspect of the present disclosure, a cassette for use in a tissue imaging system includes a first cassette portion and a second cassette portion. The first cassette portion includes a window configured to view tissue therethrough and a first connection mechanism affixed thereto. The second cassette portion includes a cavity configured to receive the tissue therein and a second connection mechanism affixed thereto. Aligning the first connection mechanism and the second connection mechanism causes the first cassette portion to couple to the second cassette portion, compressing the tissue into the cavity for imaging.

In an aspect of the present disclosure, the cassette may further include a recess formed in a central portion of the first cassette portion.

In another aspect of the present disclosure, the cavity may be substantially the same size as the recess. The cavity may be configured to receive recess therein when the first cassette portion and the second cassette portion are aligned.

In yet another aspect of the present disclosure, the recess may include a gel configured to adhere the tissue within the recess and maintain a position of the tissue therein. The gel may include agarose, formaldehyde, and/or dimethyl sulfoxide.

In a further aspect of the present disclosure, the first connection mechanism and the second connection mechanism may each include a magnet.

In yet a further aspect of the present disclosure, a lower surface of the first cassette portion may be substantially flush with an upper surface of the second cassette portion when the first cassette portion and the second cassette portion are aligned.

In an aspect of the present disclosure, the cassette may include a thermally conductive material configured to interact with a cooling system. The cooling system may be configured to maintain a temperature of the tissue in a range of approximately four to approximately six degrees Celsius.

In another aspect of the present disclosure, the cassette may further include a fixation magnet affixed to the second cassette portion. The fixation magnet may be configured to magnetically couple the second cassette portion to the cooling system and/or an imaging device.

In yet another aspect of the present disclosure, the cassette may further include a calibration component affixed to the second cassette portion. The calibration component may be configured to evaluate a performance metric of the imaging device based on light reflected towards a reflection target on window. The calibration component may include a fluorescent film and/or fluorescent microspheres.

In accordance with an aspect of the present disclosure, a tissue imaging system includes a cassette configured to retain a tissue for imaging and an imaging device. The system includes a top portion and a bottom portion. The top portion includes a window configured to view a tissue therethrough and a beam affixed thereto. The bottom portion includes a cavity configured to receive a tissue therein and groove configured to receive the beam therein. The imaging device is configured to image the tissue through the window. Aligning the beam and the groove causes the top portion to couple to the bottom portion, compressing the tissue into the cavity for imaging. A lower surface of the top portion is substantially flush with an upper surface of the bottom portion when the top portion and the bottom portion are aligned.

In accordance with an aspect of the present disclosure, a method of analyzing tissue using a tissue imaging system that includes a cassette and an imaging device. The method includes: staining a tissue with a toxic labeling agent to provide a contrast therein; placing the tissue on a lower surface of a first cassette portion; aligning a first connection mechanism of the first cassette portion and a second connection mechanism of a second cassette portion to couple the first cassette portion to the second cassette portion, compressing the tissue into a cavity of the second cassette portion; capturing an image of the tissue using the imaging device to generate a plurality of imaging assays; and training a machine learning network using the plurality of imaging assays to generate a pathology prediction.

In an aspect of the present disclosure, capturing the image of the tissue may include capturing an image using a solid-state confocal microscope.

In another aspect of the present disclosure, aligning the first connection mechanism and the second connection mechanism may include aligning at least one magnet from the first cassette portion to at least one corresponding magnet of the second cassette portion.

In yet another aspect of the present disclosure, aligning the first connection mechanism and the second connection mechanism may include aligning a lower surface of the first cassette portion to be substantially flush with an upper surface of the second cassette portion.

In a further aspect of the present disclosure, compressing the tissue into the cavity of the second cassette portion may include receiving the recess of the first cassette portion within the cavity of the second cassette portion. The cavity may be substantially the same size as the recess.

In yet a further aspect of the present disclosure, capturing an image of the tissue may include using a temperature-controlled plate to maintain a temperature of the tissue in a range of approximately four to approximately six degrees Celsius.

In an aspect of the present disclosure, compressing the tissue into the cavity of the second cassette portion may include adhering the tissue to a position within the cavity using a gel. The gel may include at least one of agarose, formaldehyde, or dimethyl sulfoxide.

In another aspect of the present disclosure, the method may further include evaluating a performance metric of the imaging device based on light reflected towards a reflection target on a window of the first cassette portion using a calibration component affixed to the second cassette portion.

In yet another aspect of the present disclosure, using a calibration component may include using at least one of a fluorescent film or fluorescent microspheres.

Further details and aspects of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying figures of which:

FIG. 1 is a perspective view of a tissue imaging system, in accordance with aspects of the present disclosure;

FIGS. 2A and 2B are views of a cassette configured for use with the tissue imaging system of FIG. 1, in accordance with aspects of the present disclosure;

FIGS. 3A and 3B are views of a bottom portion of the cassette configured for use with the tissue imaging system of FIG. 1, in accordance with aspects of the present disclosure;

FIG. 4 is a perspective view of a cassette configured for use with the tissue imaging system of FIG. 1, in accordance with aspects of the present disclosure;

FIG. 5 illustrates a tissue staining process using the cassettes of FIGS. 2A-2B and 3A-3B, in accordance with aspects of the present disclosure;

FIG. 6 illustrates a block diagram of a therapeutics assay device configured for use with the tissue imaging system of FIG. 1, in accordance with aspects of the present disclosure;

FIGS. 7A and 7B illustrate imaging data generated using the system of FIG. 1, in accordance with aspects of the present disclosure;

FIG. 8 is a flow chart of a process of tissue imaging, in accordance with aspects of the present disclosure; and

FIGS. 9A and 9B illustrates data generated using the system of FIG. 1, in accordance with aspects of the present disclosure.

### DETAILED DESCRIPTION

The present disclosure relates to systems and methods for tissue imaging, and, more specifically, to systems and methods for tissue imaging using a cassette, which may be used in confocal microscopy. Aspects of the present disclosure are described in detail with reference to the figures wherein like reference numerals identify similar or identical elements.

As used herein, “confocal microscopy” refers to an advanced imaging technique, which is used in biology, materials science, and/or other fields to obtain high-resolution images of samples. Confocal microscopy offers many advantages over traditional widefield microscopy, including improved contrast, increased resolution, and the ability to optically section specimens in three dimensions. Generally, a focused laser beam is used to scan the specimen point by point, allowing precise control over the illumination of the sample. A pinhole aperture may be placed in front of the detector to reject out-of-focus light, such that only light emitted or reflected from the focal plane of the specimen passes through the pinhole and is detected, resulting in improved optical sectioning and increased contrast. By scanning through different focal planes of the specimen, confocal microscopy can generate optical sections at different depths. This ability to optically section the specimen in three dimensions allows for the reconstruction of detailed 3D images of biological samples or other specimens.

Confocal microscopy is often used in conjunction with fluorescent labeling techniques, such as various staining techniques. Fluorescently labeled molecules or structures within the specimen emit light when illuminated with specific wavelengths of light. By using appropriate filters and detectors, confocal microscopy can selectively capture the emitted fluorescence signals, enabling the visualization of specific cellular structures or molecules within the specimen.

As used herein, “tissue” may include any type of tissue capable of being imaged. For example, tissue may refer to a group or cells and/or cells organized into a larger structure, such as an organ. Tissue may encompass animal tissue, such as epithelial tissue, connective tissue (e.g., blood), muscle tissue, and/or nervous tissue. In another example, tissue may encompass plant tissue, such as dermal tissue, ground tissue, and/or vascular tissue.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the figures, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

The tissue imaging system disclosed herein is described for use with a biological sample, which may include any material derived from a living organism that is used for scientific analysis, experimentation, and/or diagnostic purposes. A biological sample can encompass a wide range of materials, including tissues, cells, fluids, organs, and organisms themselves. For example, the tissue imaging system may be used to stain tissues, cells, blood, serum, bodily fluids, DNA, RNA, microorganisms, plant components, and/or animal models, and/or environmental samples. However, it will be understood that the tissue imaging system may be used with a variety of non-living specimens, such as inorganic materials including minerals, metals, metalloids, ceramics, glasses, semiconductors, salts and/or oxides.

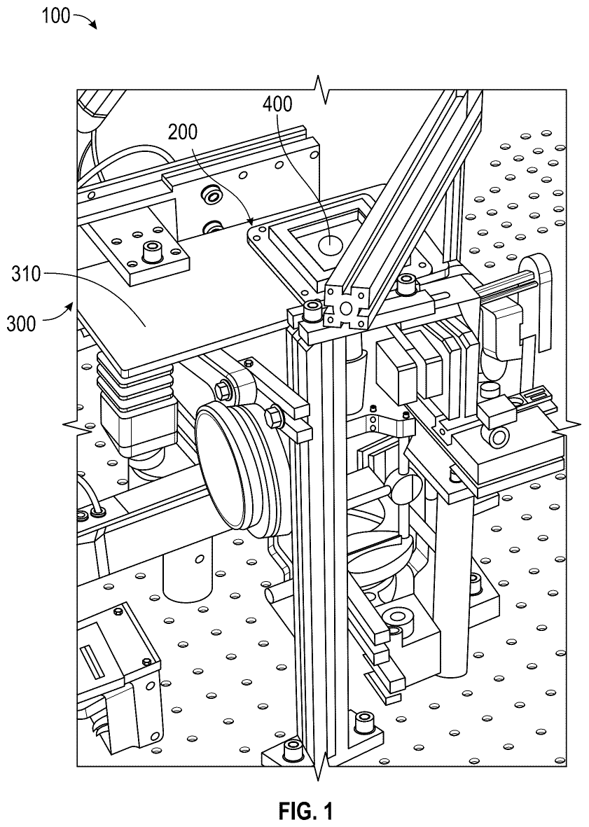

Referring to FIG. 1, a tissue imaging system 100 is shown according to aspects of the present disclosure. Tissue imaging system 100 generally includes a cassette 200, and imaging device 300. Cassette 200 is configured to retain tissue 400 therein for imaging and is coupled to imaging device 300. Imaging device 300 is configured to image tissue 400. Cassette 200 may be coupled to base plate 310 of imaging device 300 to assist during the imaging process (e.g., a microscope stage).

Imaging device 300 is generally a sold-state confocal microscope. For example, after alignment, imaging device 300 may have stationary components, which are locked into place and/or detached from a mechanism of alignment motion, such as a manual micrometer and/or motorized actuator. A wide field camera may be used to image a bottom view of tissue 400 and/or specify regions of interest (ROI) for each individual piece of tissue 400. Various sensors and/or cameras may be included in imaging device 300 based on the type of imaging application, required sensitivity, speed, resolution, and/or budget. For example, cameras and/or sensors used to further assist with imaging tissue 400 can include photomultiplier tubes (PMTs), avalanche photodiodes (APDs), hybrid detectors (HyD), charge-coupled devices (CCDs), and/or complementary metal-oxide-semiconductor (CMOS) sensors. In aspects, imaging device 300 may be configured for point-scanning confocal microscopy, spinning disk confocal microscopy, and/or spectral imaging.

Base plate 310 is typically a fixed platform, such as a single position stage (SPS), configured to hold cassette 200 thereon for imaging. In aspects, base plate 310 may be a temperature-controlled plate configured to maintain a temperature of cassette 200 and/or tissue 400. For example, base plate 310 may maintain an optimal temperature to preserve tissue 400 for live cell and/or biomolecular rescue in the presence of illumination (e.g., laser heating) during imaging (e.g., 4-6° Celsius). In aspects, cassette 200 may include a thermally conductive material and/or component, which is configured maintain a temperature of tissue 400 (e.g., from about 2 to about 4 degrees Celsius). In aspects, thermally conductive material of cassette 400 may be configured to interact with a cooling system (e.g., a system within and/or adjacent base plate 310). The thermally conductive material may be a thermal pad, or any other material and/or thermal coupling mechanism used to enhance a cooling effect of the cooling system. The cooling system may be a thermally conductive system including fans, liquids, and/or electrical components used to enhance heat dissipation from cassette 200. For example, the cooling system may be a thermoelectric cooler such as a Peltier cooler. In aspects, the cooling system may be pre-programmed and/or controllable by a user to maintain a preset temperature.

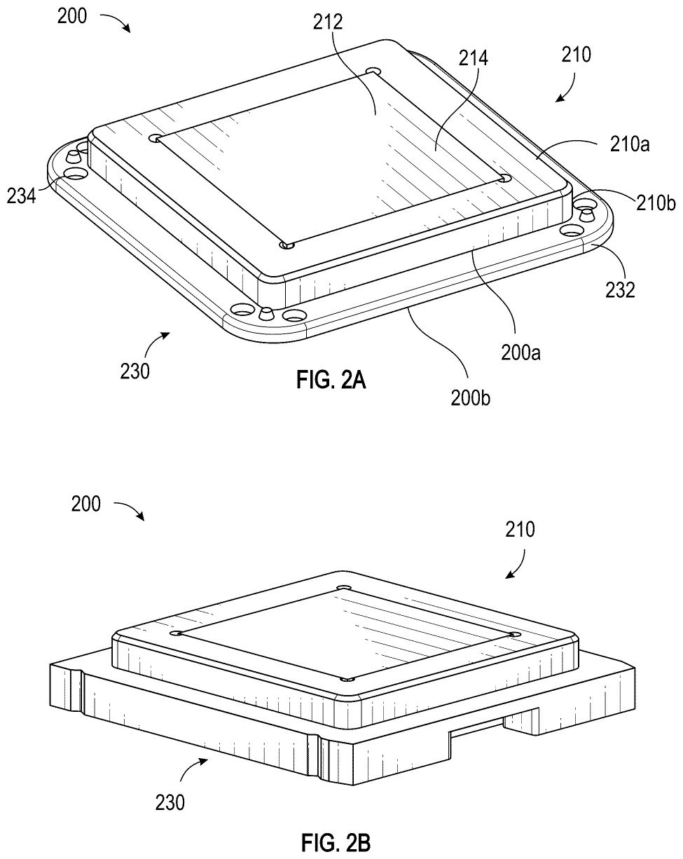

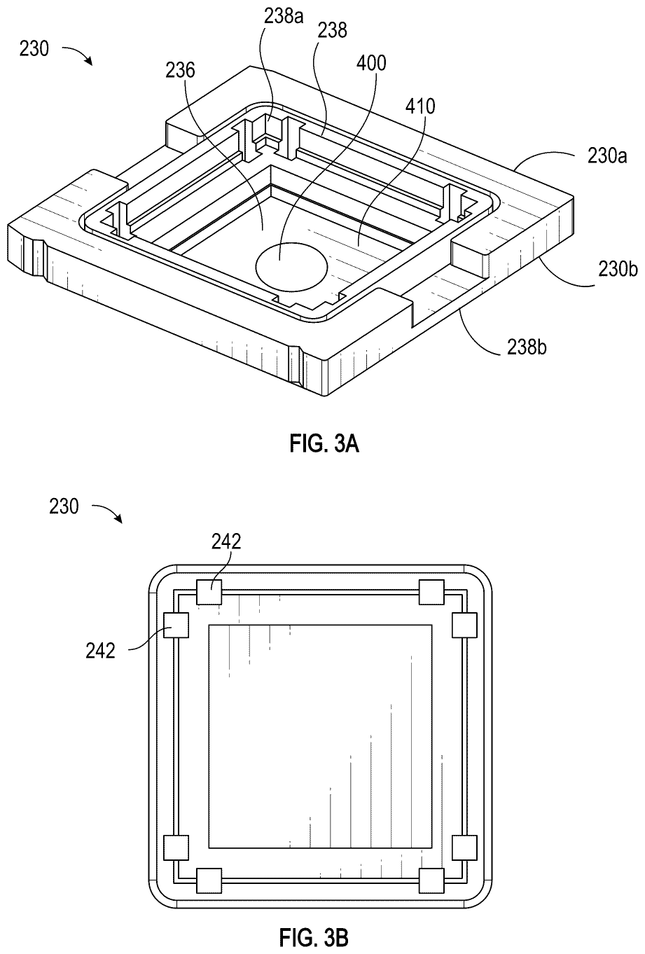

Now referring to FIGS. 2A, 2B, 3A, and 3B, cassette 200 includes a first portion 210 (e.g., a cover) and a second portion 230 (e.g., a base), which form a first outer perimeter 200a and a second outer perimeter 200b. Generally, cassette 200 is composed of a durable polymer and/or plastic, although alternative materials are contemplated. While shown as a square-shaped plate, various configurations for cassette 200 are contemplated (e.g., circular disc). In aspects, cassette 150 may include drainage holes (not shown) configured to drain a stain and/or rinse.

First portion 210 may be configured as a cover to compress tissue 400 inside second portion 230, thereby allowing tissue 400 to be properly imaged. First portion 110 may include an upper surface 210a, a lower surface 210b, a recess 212, and/or a window 214. Window 214 and/or recess 212 may be inserted through cavity 236 of second portion 230. In aspects, window 214 is flush with lower surface 230b (FIG. 3A). During imaging, cassette 200 may be flipped (e.g., rotated 180 degrees with first portion 210 against base plate 310), such that window 214 is flush with base plate 310. Generally, window 214 is composed of a glass plate (e.g., a viewing window) although alternative durable materials (e.g., plastic), shapes (e.g., circular) and/or suitable sizes are contemplated. Window 214 may be translucent to permit imaging of tissue 400 therein, and window 214 may be between approximately 1-10 cm in width and/or 1-10 cm in length (e.g., may be approximately 5 cm by 5 cm).

Second portion 230 may be configured to receive tissue 400 for imaging. Second portion 230 may include an upper surface 230a, a lower surface 230b, grip 232, lock 234, cavity 236, and/or inner perimeter 238. Second portion 230 may be wider than first portion 210m which is inserted therein. In aspects, upper surface 230a may include a lip extending outwards therefrom, such that a portion of upper surface 230a is wider than a portion of lower surface 230b (e.g., a larger perimeter). Conversely, lower surface 230b may include a base for stability, such that a portion of lower surface 230b is wider than a portion of upper surface 230a.

Grip 232 may be configured to promote enhanced traction and/or stability while tissue imaging system 100 is in use, e.g., to prevent dropping, slippage, and/or unintended movement of the components. Grip 232 may include various materials that promote anti-slippage, such as rubber, silicone, polyurethane, textured paints, vinyl, adhesive tapes, and/or metal gratings. In aspects, grip 232 may include a textured and/or contoured surface, ribbed grips, finger grooves/indentations, palm swells, adjustable straps, bands, and/or anti-slip coatings. Lock 234 is configured to connect second portion 230 to base plate 310. In aspects, lock 234 is a spring-loaded mechanism with male and female connectors. When second portion 230 is magnetically coupled to base plate 230, lock 234 may be snap into alignment.

In aspects, second portion 210 may include additional locking mechanisms. For example, inner perimeter 238 may include grooves 238a, 238b configured to further align with components (e.g., buttons, dovetail grooves, and/or snaps) within first portion 210. In aspects, second portion 230 may include a gasket (not shown) to enhance an air-tight seal and/or liquid-tight seal, such as an O-ring to reduce leakage of substances therefrom.

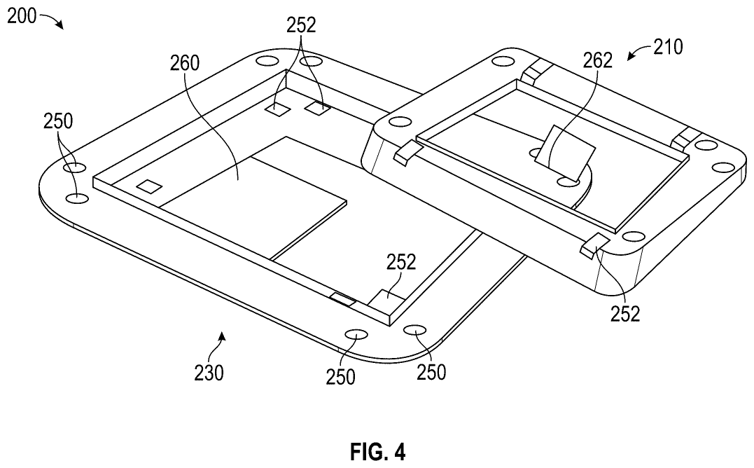

With reference now to FIG. 4, first portion 210 and second portion 230 may include Fixation magnets 250 and compression magnets 252. Fixation magnets 250 are configured to magnetically couple cassette 200 to a portion of imaging device 300, such as base plate 310. For example, Fixation magnets 250 may align with a magnetized and/or metal portion of base plate 310. Generally, fixture magnets are affixed to upper surface 230a of second portion 230 on corners thereof, as shown in FIG. 3 (e.g., two in each of the four respective corners). In aspects, Fixation magnets 250 may be affixed to various alternative surfaces of second portion 230 and/or first portion 210 (e.g., a lip, lower surface, and/or central area thereon).

Compression magnets 252 are configured to magnetically couple first portion 210 to second portion 230. Generally, compression magnets 252 are affixed to second portion 230 on a surface of cavity 236, e.g., on corners thereof, and affixed to first portion 210 on lower surface 210b. When compression magnets 252 of first portion 210 and second portion 230 are aligned, compression magnets 252 adhere to one another to magnetically couple first portion 210 and second portion 230. In aspects, compression magnets may be affixed to various alternative surfaces of second portion 230 and/or first portion 210 (e.g., formed in a central region between upper surface 210a and lower surface 210b). Any number of magnets and/or arrangements are contemplated for Fixation magnets 250 and/or compression magnets 252 (e.g., multiple rows or along entire perimeter).

In aspects, additional and/or alternative coupling mechanisms are contemplated for first portion 210 and second portion 230, such as mechanical coupling and/or snap-fit coupling. For example, first portion 210 may include buttons (not shown) configured to fit into grooves 238a, 238b. In another example, first portion 210 and second portion 230 may be coupled via threading. In aspects, hooks, clasps, gluing, locks, and/or welding may be used.

Second portion 230 may include a calibration component 260 and/or reflection target 262 configured to calibrate imaging device 300, evaluate reflectance imaging performance, and/or provide quality management (e.g., imaging performance metrics), which ensures imaging is of sufficient quality for pathology evaluation of tissue 400. Calibration component 260 may include a reflectance and/or a fluorescence portion configured to reflect light to be aligned with reflection target 262. For example, calibration component 260 may include a fluorescent film (e.g., a thin fluorescent plastic film) and/or fluorescent microspheres configured to evaluate the fluorescent imaging performance of imaging device 300. When calibration component 260 containing such a fluorescent film is pressed against window 214, tissue imaging system 100 generates imaging performance metrics such as fluorescent sensitivity, lateral resolution, and/or optical section thickness.

In aspects, calibration component 260 may include a patterned structure and/or grid including reflection targets on window 214. For example, calibration component 260 may include a reflection target 262 in triplicate, e.g., three reflection targets 262 are placed in a triangle formation at different locations on the window 214, enabling definition of a surface of window 214 in space by axial imaging scans at the three locations of reflection targets 262.

Imaging device 300 may be aligned using calibration component 260. For example, microscope alignment may be performed by moving components of imaging device 300 focused on calibration component 260 to optimize imaging performance metrics. In aspects, an alignment algorithm may be used to implement alignment, e.g., a method where a cost function is minimized as a function of component positions of imaging device 300, e.g., optical components are aligned to produce high-quality images. For example, when observing a reflective pattern through a microscope, a well-aligned optical path will display a pattern of calibration component 260 in a sharp and/or symmetrical manner, e.g., aligning with reflection targets.

Calibration component 260 may be used to calculate axial and/or lateral resolution of imaging device 300. In microscopy, a high axial resolution may be achieved using point illumination and detection. Thus, calculating axial resolution generally includes determining a minimum distance along the imaging axis (depth) at which two distinct points can be identified) by verifying the resolving power of imaging device 300 in a depth direction. Calibration component 260 may further be configured to calculate a reflectance sensitivity of imaging device 300 and/or an optical section thickness.

In aspects, calibration component 260 may be used to specify a tip and/or tilt of window 214. For imaging purposes, alignment quality management may be based on a worst tip and/or tilt value of three coordinates on a portion of imaging device, e.g., on base plate 310. An image scanning algorithm may be used, which varies the Z position of the focal plane to track a surface of window 214 and/or surface beneath within tissue 400 during lateral scans. In doing so, tissue imaging system 100 may track a surface of tissue 400 in the presence of tip and/or tilt misalignment when window 214 is not perfectly parallel with a microscope focal plane of imaging device 300.

With reference again to FIG. 3A, tissue 400 and gel 410 are configured to be housed within cavity 236 of second portion 230. Tissue 400 may include various types of tissue, including epithelial tissue, connective tissue (e.g., bone, cartilage, adipose tissue, blood, lymphoid tissue), muscle tissue, and/or nervous system tissue, although alternative samples are contemplated. In aspects, tissue 400 may adhere to gel 410. Gel 410 may be an adhesive gel material, which is configured to allow for compression of tissue 400 while maintaining stability thereof, e.g., minimizing movement or deformation of tissue 400 during imaging, preventing dislodging of tissue 400 from gel 410, and/or and providing optical clarity for visualization. For example, gel 410 may maintain tissue 400 therein during staining and/or rinsing, and/or when cassette 200 is orientated upside-down.

Generally, gel 410 may contain between 1-10% agarose (e.g., 3% weight by volume), which may be crosslinked with a polyacrylate to increase adhesion with tissue 400. In aspects, gel 410 may include low melt agarose, alginate with laminin, and/or collagen. Gel 410 may have a thickness of between 5 mm-15 mm (e.g., 10 mm). Gel 410 may have a fractional gel thickness deformation under loading (e.g., caused by magnetic coupling first portion 210 and second portion 230) of between 10-30% (e.g., 20% or 2 mm). In aspects, gel 410 may include gel concentration with mechanical properties, methylcellulose and/or cyanoacrylate to promote adhesion of tissue 400 to gel 410. Various thicknesses and/or concentrations of substances in gel 410 may differ based on various factors, such as those impacted by biospecimen variability of solid tissue 400 biopsies.

Additional and/or alternative gel 410 formulations are contemplated to promote adhesion, including glycerol gel, mounting mediums with gelatin, polyvinyl alcohol (PVA) gel, superglue, and/or embedding mediums. For example, gel 410 may include passive/inactive ingredients for providing increased stiffing and/or cold-foaming abilities, which permit tissue 400 to be gently compressed into window 214 (disclosed below) and/or flattened therein for proper in-plane imaging (e.g., along a specific plane or slice of tissue 400) without inducing excessive force that may damage tissue 400. In aspects, gel 410 may include various active ingredients that assist with primary pathology imaging of tissue 400. For example, gel 410 may include contrasts ingredients such as immunohistochemical stains to enhance optical imaging for pathological analysis purposes.

In aspects, gel 410 may include various active ingredients for aiding with downstream processes after the primary pathology imaging of tissue 400. For example, gel 410 may include formaldehyde and/or formalin to aid in chemical fixation, e.g., chemically fixing tissue 400 therein, which allows compatibility with pathology processes complementary to confocal pathology (e.g., standard formalin-fixed, paraffin-embedded pathology). In another example, gel 410 may include a cryoprotectant, such as 10% dimethyl sulfoxide (DMSO) to aid in cryopreservation of tissue 400, e.g., by protecting living cells.

In use, tissue 400 is placed onto the inside of window 214, e.g., on lower surface 210b of first portion 210, and gel 410 is then applied to cavity 236 of second portion 230. When ready, first portion 210 and second portion 230 are magnetically coupled, causing lower surface 210b of first portion 210 to compress against upper surface 230a of second portion 230. Generally, first outer perimeter 200a is smaller than second outer perimeter 200b, and inner perimeter 238 is slightly larger than second outer perimeter 200b, e.g., approximately 5 cm in diameter, although any number of perimeters may be the same and/or differently sized. Additional fixation features, such as grooves 238a, 238b and lock 234 may be utilized to further couple first portion 210 to second portion 230.

During compression of first portion 210 against second portion 230, tissue 400 is compressed into gel 410. Generally, first portion 210 is placed on a surface and second portion 230 is oriented upside down, so that gel 410 is pressed into window 214. In doing so, a part of first portion 210 may be substantially flush with a part of second portion 230. For example, lower surface 210b may be substantially flush with upper surface 230a. Grip 232 may be held during compression to ensure better control of cassette 200. Once compression is complete, cassette 200 may be placed into imaging device 300 for imaging. Window 214 may flush with lower surface 210b of first portion 210, cavity 236, and/or upper surface 230a of second portion, thereby permitting imaging device 300 to scan tissue 400 in cassette 200 from a distance while avoiding contact therewith. For example, window 214 may permit a lens of imaging device 300 to scan tissue 400 from about 180 to about 220 μm away without contacting any portion of cassette 200. In aspects, window 214 and/or recess 212 may be substantially inserted within cavity 236.

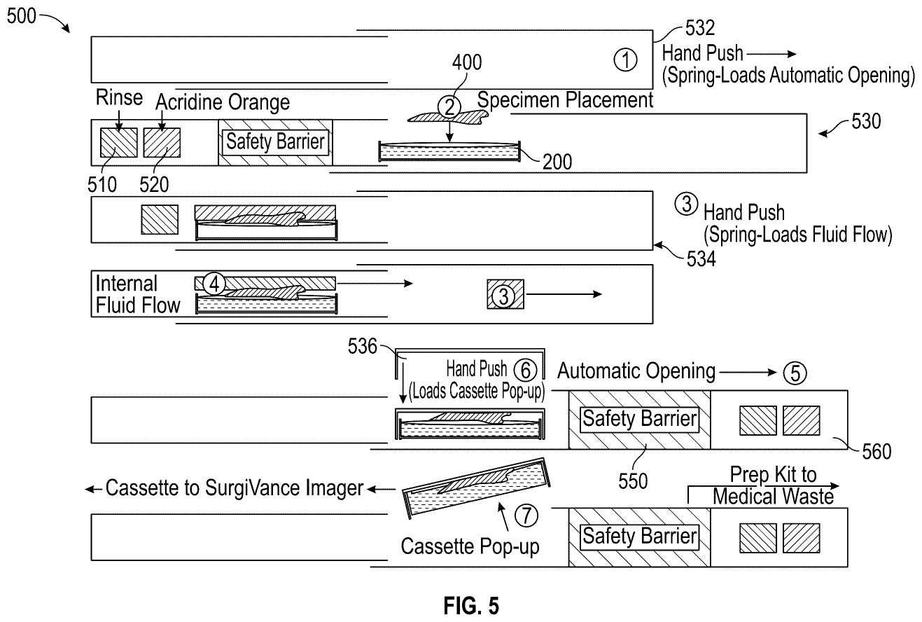

Now referring to FIG. 5, tissue 400 may be stained prior to imaging using a tissue staining apparatus 500. Tissue staining apparatus is a specialized device configured to contain a toxic labeling agent (e.g., a stain 520) for rapid, strong contrast with risk mitigation and is implemented with a lab-grade mitigation protocol including a rinse 510. In aspects, stain 520 is acridine orange and rinse 510 is a Phosphate-Buffered saline (PBS). Tissue staining apparatus 500 may be a disposable device and/or may include a collection tube 530, which uses a breakable cap to contain toxic reagents (e.g., stain 520) until the user seals the sample (e.g., tissue 400) within the device. In aspects, the same motion that seals the device may also break the cap releasing the stain. Tissue staining apparatus 500 may also include a timed, mechanical fluid flow to direct stain 520 and/or a rinse 510 across tissue 400 and unto a second safety sealed well 560. In aspects, gravitational forces may be utilized for transporting fluids for staining and/or rinsing tissue 400. For example, tissue staining apparatus 500 may be turned upside-down to let a liquid drain back into a reservoir and/or perform a rinsing function.

For example, as illustrated in FIG. 5, a hand-pull 532 (e.g., spring-loaded automatic opening) may be used to expose an inner wall of collection tube 530 for placement of cassette 200 therein. A hand push 534 (e.g., spring-loaded automatic fluid flow) may be used to push collection tube 530 closed, breaking the seal to the stain 520 and/or rinse 510. In doing so, tissue 400 is properly stained and the surrounding, exposed surfaces (e.g., gel 410) are sufficiently rinsed to contain levels of the toxic agent (e.g., stain 520) that are within the safety thresholds for medical waste. First portion 210 of cassette 200 is then magnetically coupled to second portion 230, and further compression triggers automatic opening of collection tube 350 and/or ejection of cassette 200. The device illustrated in FIG. 5 is exemplary, and various configurations of tissue staining apparatus 500 are contemplated. Other exemplary devices for tissue staining are disclosed in U.S. patent application Ser. No. 18/646,604, entitled “Systems and Methods for Tissue Staining,” the entire contents of which are incorporated by reference herein.

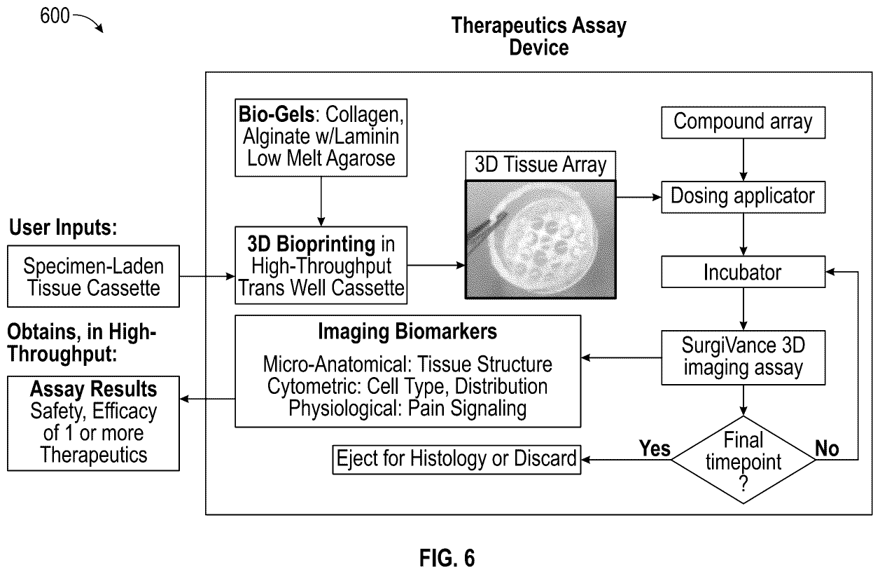

Now referring to FIG. 6, a therapeutics assay device 600 may be configured to receive cassette 200 and automatically process tissue 400 for analysis. For example, therapeutics assay device 600 may automatically extract living cells from tissue 400 combined with gel 410 (e.g., bio-gels) to generate three-dimensional (3D) tissue cultures. For example, therapeutics assay device 600 may generate 3D tissue cultures in arrays for compound testing based on imaging assays by imaging device 300. As a result, therapeutics assay device 600 may generate patient-specific data (e.g., diagnostic results), which may predict the prognosis of a patient's health. For example, therapeutics assay device 600 may analyze tissue 400 to generate predictions regarding the prognosis of a patient's disease (e.g., cancer) when exposed to various chemotherapy agents.

Therapeutics assay device 600 may include various additional tissue processing components. For example, therapeutics assay device 600 may include a 3D bioprinting component configured for high-throughput trans well cassette processing. In another example, therapeutics assay device 600 may include an imaging biomarkers component configured to analyze micro-anatomical features of tissue 400 (e.g. tissue structure), cytometric details (e.g., tissue cell type and distribution), and/or physiological data (e.g., pain signaling). For example, imaging biomarkers component may utilize machine learning to display biomarkers including overlaid analog probability maps onto images of tissue 400 indicative of various tissue features.

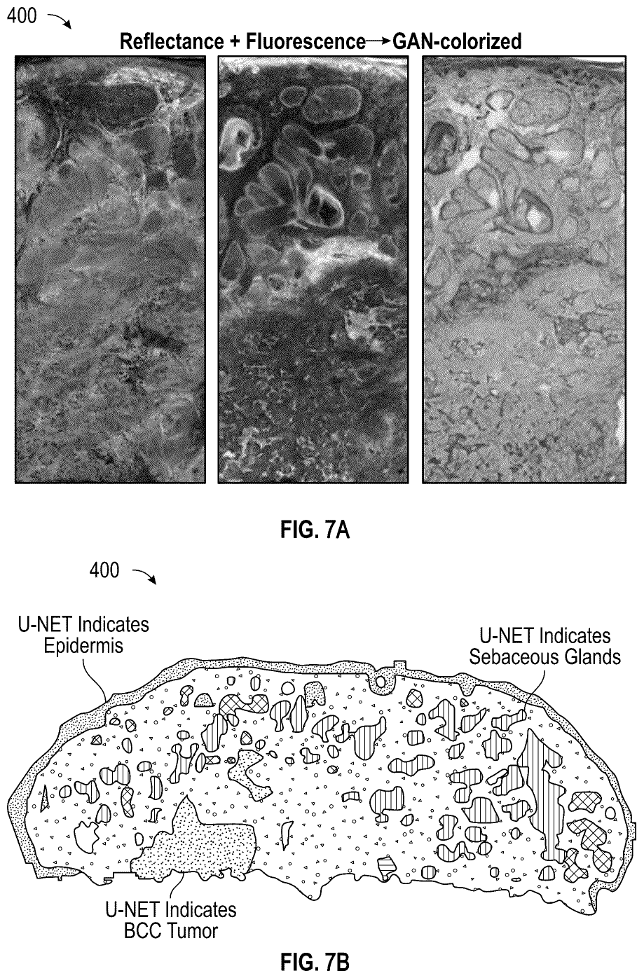

Now referring to FIGS. 7A and 7B, various post-imaging techniques may be performed based on the imaging tissue 400. For example, tissue imaging system 100 may perform standard histopathology and/or evaluation of biomolecules (e.g., RNA expression signatures and gene tests), and/or rescuing of live cells for further diagnostic, prognostic, and/or therapeutic assay tests. Generally, tissue imaging systems 100 utilizes direct-to-digital confocal pathology, which is a slide-free imaging method performed on whole tissue without microscopic resolution. Thereafter, machine learning trained on a variety of diagnostic imaging may be employed to identify structures in the imaging, e.g., in the tissue 400 pictured, using a machine learning network. For example, a machine learning algorithm may operate on a set of multimodal confocal imaging wavelengths (e.g., excitation and/or emission wavelengths) for reflectance and fluorescence imaging modes and/or imaging at multiple excitation and/or emission wavelengths.

With further reference to FIG. 7A, a generalized adversarial network (GAN) may be used to transform confocal images of tissue 400 into a colorized style, which can be useful for visualizing and analyzing confocal microscopy data. Such colorized images may be highly accurate and mimic the appearance of standard histopathology. To do so, the GAN may be trained to learn the mapping between grayscale confocal images and colorized versions of the same confocal images. First, a dataset of grayscale confocal images along with their corresponding colorized versions is gathered. The colorized images can either be manually colorized by experts or obtained from existing datasets. The images may be preprocessed as needed, which may include resizing, normalization, and/or augmentation techniques to increase the diversity and robustness of the dataset. Next, the GAN may be trained with this preprocessed dataset. After training, the trained GAN may be validated on a separate dataset to assess performance and generalization ability, which can ensure that the GAN is producing high-quality colorized images that are faithful to the original grayscale confocal images. Once the GAN has been trained and validated, it can be used to colorize new grayscale confocal images. The trained generator network takes grayscale confocal images as input and outputs colorized versions.

With further reference to FIG. 7B, deep learning techniques may be used to identify diseases within the colorized confocal images of tissue 400, enabling rapid and accurate analysis of medical imaging data for diagnostic and research purposes. For example, a convolutional neural network (CNN) may be utilized to predict cancer tissues (e.g., melanomas) by learning to segment and classify regions of interest associated with cancerous tissues. For example, a diagnostic U-net may be used identify basal cell carcinoma (BCC), epidermis structures and/or adnexal structures in Mohs surgical excisions. During training, the U-Net learns to predict a binary mask indicating the presence or absence of cancerous regions for each input image. The U-Net can be trained using stochastic gradient descent (SGD) or other optimization algorithms, adjusting the network parameters to minimize the defined loss function. The U-net may be validated on a separate dataset to assess its performance and generalization ability. A performance level of the U-Net may be determined using metrics such as accuracy, precision, recall, F1-score, and area under the receiver operating characteristic (ROC) curve.

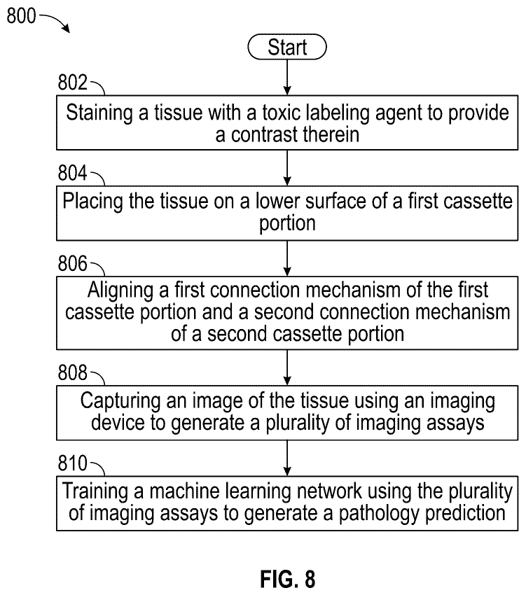

FIG. 8 shows a method 800 for an exemplary use of the tissue imaging system 100 according to aspects of the present disclosure. Although the steps of method 800 of FIG. 8 are shown in a particular order, the steps need not all be performed in the specified order, and certain steps can be performed in another order. In various aspects, the method 800 of FIG. 8 may be performed all or in part by components of tissue imaging system 100. These and other variations are contemplated to be within the scope of the present disclosure.

In step 802, tissue 400 is stained with a toxic labeling agent, e.g., a stain 520, to provide a contrast within the tissue. Generally, the stain 520 is a versatile nucleic acid such as acridine orange, although it is contemplated that various stains may be used, including fluorescein isothiocyanate (FITC), tetramethylrhodamine (TRITC), Alexa Fluor dyes, 4′,6-Diamidino-2-Phenylindole (DAPI), 1,1′-Dioctadecyl-3,3,3′,3′-Tetramethylindocarbocyanine Perchlorate (Dil), Hoechst dyes, phalloidin, and/or Calcein-AM. The acridine orange stain 520 used may be at a pH of 6.0. Generally, stain 520 is released through a controlled containment system, such as a reservoir.

After staining, the tissue 400 is typically rinsed using a solution, e.g. rinse 510, to wash the tissue after labeling and/or staining using stain. Generally, rinse 510 is a phosphate-buffered saline (PBS), although various rinses may be chosen based on factors such as the nature of the sample, the staining or labeling protocol being used, and/or the desired imaging outcomes. For example, a rinse 510 may include various buffer solutions and/or distilled water, which serve to remove excess staining reagents, reduce background fluorescence, and/or maintain sample integrity during imaging. Similar to the stain 520, the rinse 510 may be included in a controlled containment system such as a reservoir.

Next, at step 804, tissue 400 is placed on a lower surface 210b of first portion 210. For example, tissue 400 may be placed on a lower surface of window 214 adjacent to upper surface 230a of lower portion 230. At this time, first portion 210 is generally placed on a flat surface and orientated upside-down, to prevent gravity from dislodging tissue 400 from lower surface 210a. In aspects, tissue 400 may be secured to lower surface 210b using a variety of adhesion mechanisms, such as clasps, glues, and/or magnets. In aspects, while tissue 400 settles onto window 214, gel 410 may be added to cavity 236.

Next, at step 806, a first compression magnet 252 of first portion 210 is aligned with a second compression magnet 252 of second portion 230. For example, a set of eight magnets placed on corners of each of first portion 210 and second portion 230 may be aligned to cause magnetic coupling thereto. In aspects, compression magnets 250 may be affixed to various alternative surfaces of second portion 230 and/or first portion 210 (e.g., a lip, lower surface, and/or central area thereon). Compression magnets 252 may include permanent magnets and are contemplated to be any shape or size that fits within the body of cassette 200. In aspects, compression magnets may be replaced with locking mechanisms.

In addition, fixation magnets 250 on second portion 230 may be aligned with fixation magnets 250 on imaging device, such as on base plate 310. In aspects, fixation magnets 250 on second portion 230 may align with a magnetized and/or metal portion of base plate 310. Generally, fixture magnets are affixed to upper surface 230a of second portion 230 on corners thereof, although alternative arrangements are contemplated. In aspects, alternative methods of fixation for cassette 200 and/or imaging device 300 are contemplated. For example, first portion 210 may include a beam (not shown) configured to be received within a groove 238a, 238b of second portion 230. In aspects, a lock or snap-fit mechanism (not shown) may be used to couple first portion 210 to second portion 230, such as a latch on first portion 210 configured to lock into grooves 238b.

Cavity 236 is substantially the same size as recess 212. Therefore, after first portion 210 and second portion 230 are aligned, recess 212 is placed in cavity 236, causing tissue 400 to be compressed into gel 410 housed within cavity 236. When first portion 210 and second portion 230 are aligned and/or coupled, lower surface 210a of the first portion 210 is substantially flush with an upper surface 230a of the second portion 230. In aspects, a portion of first portion 210 may protrude from cavity 236 and/or may be substantially flush.

Gel 410 may include various active ingredients for aiding with downstream processes after the primary pathology imaging of tissue 400. For example, gel 410 may include formaldehyde to aid in chemical fixation. During compression, base plate 310 and/or a cooling system may be used to maintain a stable temperature of gel 410 and/or tissue 400. In aspects, a temperate-controlled plate and/or component may be included within cassette. Once tissue 400 is secured within gel 410, cassette 200 may be reoriented right-side up, e.g., with first portion 210 on top, for imaging.

Next, at step 808, imaging device 300 may capture an image of tissue 400 to generate imaging assays. Prior to imaging, imaging device 300 may be calibrated using calibration component 260 and/or reflection target 262. For example, microscope alignment may be performed by moving components of imaging device 300 focused on calibration component 260 to optimize imaging performance metrics, which may be evaluated based on light reflected towards a reflection target 262 on window 214. Calibration component 260 may include a fluorescent film and/or fluorescent microspheres configured to evaluate the fluorescent imaging performance of imaging device 300.

When fully calibrated, imaging device 300 may capture an image of tissue 400 for analysis. For example, a wide field camera may be used to image a bottom view of tissue 400 and/or specify regions of interest (ROI) for each individual piece of tissue 400. Typical image types captured may include optical sections, fluorescence images, 3D reconstructions, multicolor and/or multiplex images, reflection images, Förster Resonance Energy Transfer (FRET) images, spectral images, and/or Fluorescence Lifetime Imaging Microscopy (FLIM) images. The captured images may be stored in a database and/or sent to a network for further analysis.

Finally, at step 810, a machine learning network is trained using the imaging assays to generate a pathology prediction. A machine learning network may include, for example, a convolutional neural network (CNN), a regression and/or a recurrent neural network. The machine learning network 320 may leverage one or more classification models (e.g., CNNs, decision trees, a regression, Naive Bayes, k-nearest neighbor) to classify data within tissue 400 imaging. In aspects, the classification model may use a data file and labels for classification.

Tissue imaging system 100 typically uses direct-to-digital confocal pathology, which is a slide-free imaging method performed on whole tissue 400 without microscopic resolution. Thereafter, the machine learning trained on a variety of diagnostic imaging may be employed to identify structures in the imagine, e.g., in the tissue pictured, e.g., using machine learning. The analysis of machine learning may generate a pathology prediction, such as the presence and/or absence of melanoma in tissue 400 treated with chemotherapy agents.

In aspects, the results (e.g., imaging and/or diagnosis) generated by tissue imaging system 100 may be displayed on a user device, such as a mobile device. A mobile device may include a cellular device, tablet, personal computer, laptop, and/or virtual reality headset. For example, results may appear within an application on a tablet used by a clinician including detailed recommendations. In aspects, display may include a visual, audio, and/or haptic alert indicating the presence of one or more diagnostic results.

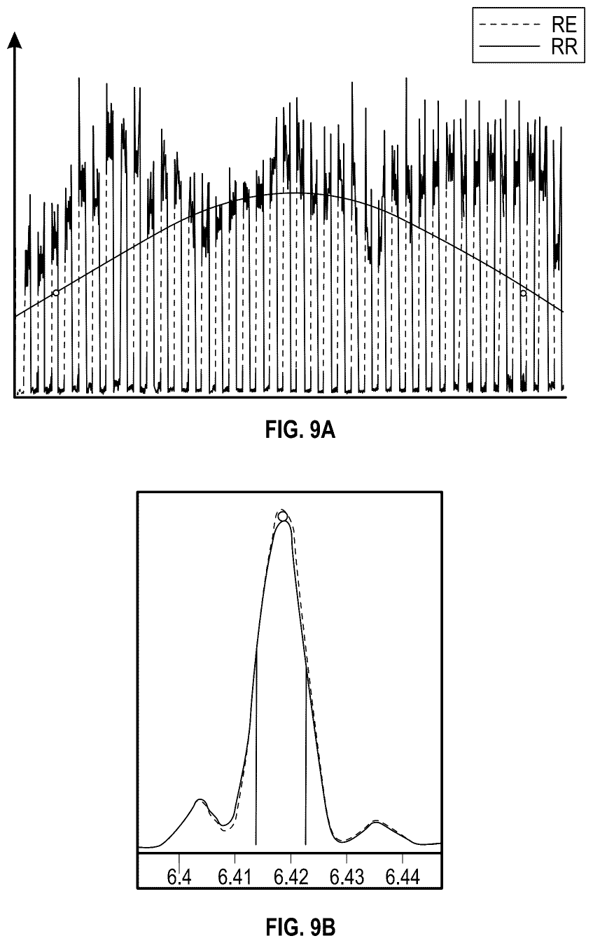

FIGS. 9A and 9B illustrate calibration data generated from imaging a calibration target using the system of FIG. 1. As shown in FIG. 9A, a lateral resolution of a microscope system (e.g., imaging system 300) was measured by an apparent width of a mirror edge (e.g., reflection target 262) from a calibration target (e.g., calibration component 260). The horizontal axis represents a field of view along a focused lase light line (Y) axis, and the vertical axis represents pixel intensity, where RE=the average rising edge and RR=the reflection image off a mirror grating target (e.g., ronchi ruling). For example, the mirror edge may have a width of 1.2 μm from the calibration target. An average rising edge (e.g., lateral resolution)=1.2+/−0.6 μm. As shown in FIG. 9B, system 100 was tested with an optical section thickness as demonstrated by the full width half maximum (FWHM) of the line spread function (LSF) with a full width half maximum of 8 μm and measured a line-spread function (axial resolution) as indicated by the top point of approximately 6.42 mm.

Certain aspects of the present disclosure may include some, all, or none of the above advantages and/or one or more other advantages readily apparent to those skilled in the art from the figures, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. A tissue imaging system including a cassette configured to retain a tissue for imaging, the system comprising:
a first cassette portion including:
a recess formed in a central portion thereof;
a window formed within the recess; and
a first connection mechanism affixed thereto;
a second cassette portion including:
a cavity configured to compress a tissue therein; and
a second connection mechanism affixed thereto; and
an imaging device configured to image the tissue through the window,
wherein aligning the first connection mechanism and the second connection mechanism causes the first cassette portion to couple to the second cassette portion, compressing the tissue into the cavity for imaging.

2. The system of claim 1, wherein the imaging device is a solid-state confocal microscope.

3. The system of claim 1, wherein the first connection mechanism and the second connection mechanism each include at least one magnet.

4. The system of claim 1, wherein the cavity is substantially the same size as the recess, and the cavity is configured to receive recess therein when the first cassette portion and the second cassette portion are aligned.

5. The system of claim 4, wherein a lower surface of the first cassette portion is substantially flush with an upper surface of the second cassette portion when the first cassette portion and the second cassette portion are aligned.

6. The system of claim 1, further comprising a temperature-controlled plate configured to maintain a temperature of the tissue in a range of approximately four to approximately six degrees Celsius.

7. The system of claim 6, further comprising at least one fixation magnet affixed to the second cassette portion, the at least one fixation magnet configured to magnetically couple the second cassette portion to the temperature-controlled plate.

8. The system of claim 1, wherein the recess includes a gel configured to adhere the tissue within the recess and maintain a position of the tissue therein, the gel including at least one of agarose, formaldehyde, or dimethyl sulfoxide.

9. The system of claim 1, further comprising a calibration component affixed to the second cassette portion, the calibration component configured to evaluate a performance metric of the imaging device based on light reflected towards a reflection target on window.

10. The system of claim 9, wherein the calibration component includes at least one of a fluorescent film or fluorescent microspheres.

11. A cassette for use in a tissue imaging system, the cassette comprising:
a first cassette portion including:
a window configured to view tissue therethrough; and
a first connection mechanism affixed thereto;
a second cassette portion including:
a cavity configured to receive the tissue therein; and
a second connection mechanism affixed thereto;
wherein aligning the first connection mechanism and the second connection mechanism causes the first cassette portion to couple to the second cassette portion, compressing the tissue into the cavity for imaging.

12. The cassette of claim 11, further comprising a recess formed in a central portion of the first cassette portion.

13. The cassette of claim 12, wherein the cavity is substantially the same size as the recess, and the cavity is configured to receive recess therein when the first cassette portion and the second cassette portion are aligned.

14. The cassette of claim 12, wherein the recess includes a gel configured to adhere the tissue within the recess and maintain a position of the tissue therein, the gel including at least one of agarose, formaldehyde, or dimethyl sulfoxide.

15. The cassette of claim 11, wherein the first connection mechanism and the second connection mechanism each include at least one magnet.

16. The cassette of claim 11, wherein a lower surface of the first cassette portion is substantially flush with an upper surface of the second cassette portion when the first cassette portion and the second cassette portion are aligned.

17. The cassette of claim 11, further comprising a thermally conductive material configured to interact with a cooling system, wherein the cooling system is configured to maintain a temperature of the tissue in a range of approximately four to approximately six degrees Celsius.

18. The cassette of claim 17, further comprising at least one fixation magnet affixed to the second cassette portion, the at least one fixation magnet configured to magnetically couple the second cassette portion to at least one of the cooling system or an imaging device.

19. The cassette of claim 17, further comprising a calibration component affixed to the second cassette portion, the calibration component configured to evaluate a performance metric of the imaging device based on light reflected towards a reflection target on window, wherein the calibration component includes at least one of a fluorescent film or fluorescent microspheres.

20. A tissue imaging system including a cassette configured to retain a tissue for imaging, the system comprising:
a top portion including a window configured to view a tissue therethrough and a beam affixed thereto;
a bottom portion including a cavity configured to receive the tissue therein and groove configured to receive the beam therein; and
an imaging device configured to image the tissue through the window,
wherein aligning the beam and the groove causes the top portion to couple to the bottom portion, compressing the tissue into the cavity for imaging, and wherein a lower surface of the top portion is substantially flush with an upper surface of the bottom portion when the top portion and the bottom portion are aligned.
